(19) United States
(12) Patent Application Publication
(10) Pub. No.: US 2016/0176101 A1
(43) Pub. Date: Jun. 23, 2016

(54) POSITIONING DEVICE FOR PASTING A FILM

(71) Applicant: Zhengjie FAN, Guangzhou City (CN)

(72) Inventor: Zhengjie FAN, Guangzhou City (CN)

(21) Appl. No.: 14/959,526

(22) Filed: Dec. 4, 2015

(30) Foreign Application Priority Data
Dec. 18, 2014 (CN) 201420804161.1
Sep. 29, 2015 (CN) 201520763049.2

(51) Int. Cl. B29C 63/00; B29C 63/02

(52) U.S. Cl. CPC B29C 63/0004; B29C 63/02; B29C 2063/0008; B29L 2031/3475

(57) ABSTRACT

A positioning device for pasting a film is provided. The positioning device is suitable for auxiliary positioning when pasting a screen protecting film to an electronic device and the electronic device has a functional port in its bottom end surface and has a button on its front surface adjacent to the functional port, wherein the positioning device comprises: a tail board parallel to a back side of the electronic device, a bottom supporting board perpendicular to the tail board and integrally formed with the tail board, a surface pressing board parallel to the tail board and connected with the bottom supporting board, a pin provided on an inner side of the bottom supporting board and extending inwards and having a shape and a size matching with that of the functional port, and a positioning element engagable with the button which is provided on an inner side of the surface pressing board and projects inwards and has a shape and a size matching with that of the button. In addition, the tail board is provided on an outer side of the bottom supporting board.

### CROSS-REFERENCE TO RELATED APPLICATION

This application claims priority benefit from Chinese utility model applications No. 201420804161.1 filed on 18 Dec. 2014, and No. 201520763049.2 filed on 29 Sep. 2015, both of which are incorporated by reference.

### FIELD OF THE INVENTION

The present invention relates to auxiliary means for pasting a film and in particular, relates to a positioning device for pasting a film.

### BACKGROUND OF THE INVENTION

Electronic devices with touch screens are more and more widely used nowadays. Most of mobile phones and tablets utilize touch screens for operation. To protect the touch screen from scratching, a protecting film is generally pasted on the screen. The film is usually pasted by hand after selling of the electronic devices. For an electronic device with a wide boundary, it is not obvious or noticeable if the film is not pasted in an exactly right position, which will not affect the user's viewing or operation. In addition, electronic devices are often provided with a flat edge, thus a film that is produced a little lager will facilitate its pasting and will not affect the user's looking at the screen, and in such a case, the film will not bend upwards easily.

However, with development of technologies, electronic devices are produced more and more subtly, which makes the screen edge or boundary more and more narrow. Further, more electronic devices are provided with a rounded corner to provide a better feeling when holding the electronic devices. For the electronic devices with a narrow screen edge and a rounded corner, the film must have a very precise size and there will be very little space left after being pasted. If the film is not pasted in an exactly right position, one edge of the film will fall inside the screen area and thus affect the operation and viewing, while another edge will extend outside of the screen area and hang over the round corner, which makes the edge of the film easy to bend upwards. Such films should be removed and be replaced by another film, which is a waste of not only materials but also time and effort of the man who pasted the film.

Even for an experienced person, it is hard to complete the film pasting with such high requirements in a fast and precise way, which is therefore still time-consuming and not easy to get a precise positioning. Since labor charges is high in some area, manual film pasting costs more than buying more films. Consumers would rather waste more films and paste the film by themselves, which results in a waste of materials and even in such a case, the film is still not pasted precisely and operation of the electronic device may thus be affected.

### SUMMARY OF THE INVENTION

To overcome the disadvantages in prior art, a positioning device for pasting a film is provided by the present invention, to facilitate consumers to paste a screen protecting film to an electronic device in a fast and precise way.

A positioning device for pasting a film is provided to solve the above technical problems. The positioning device is suitable for auxiliary positioning when pasting a screen protecting film to an electronic device. Particularly, the electronic device has a functional port in its bottom end surface and has a button on its front surface adjacent to the functional port. The positioning device comprises: a tail board parallel to the back side of the electronic device, a bottom supporting board perpendicular to the tail board and integrally formed with the tail board, a surface pressing board parallel to the tail board and connected with the bottom supporting board, a pin provided on the inner side of the bottom supporting board and extending inwards and having a shape and a size matching with the shape and size of the functional port, and a positioning element engagable with the button which is provided on the inner side of the surface pressing board and projects inwards and has a shape and a size matching with the shape and size of the button. In addition, the tail board is provided on the outer side of the bottom supporting board.

Preferably, the back side of the tail board is in alignment with the back side of the electronic device.

Preferably, the positioning device further comprises a back board. The back board is provided on the back side of the electronic device and parallel to the surface pressing board. The back board is integrally formed with the bottom supporting board.

Preferably, board shaped positioning wings are formed by the bottom supporting board extending to its left and right sides. A guiding slope is provided in the front end of the back board.

Preferably, the bottom supporting board is provided with a slot, and the surface pressing board is provided with a plug for non-rotatable engaging with the slot.

Preferably, the plug is a flat positioning pin perpendicularly provided on the inner side of the surface pressing board.

Preferably, the surface pressing board is integrally formed with the bottom supporting board.

Preferably, a front end portion of the surface pressing board is in a shape and a size consistent with the shape and the size of the positioning element, and a connecting neck portion of the surface pressing board is smaller than the positioning element.

Preferably, the positioning element is in a circular shape, and the part of the front end portion of the surface pressing board that is in a shape and a size consistent with the shape and the size of the positioning element is more than or equal to 240° of the circumference of the circular shape.

Preferably, the surface pressing board is provided with laterally extending wings on its two sides for preventing upwards extending of the film.

Preferably, the positioning device further comprises: a base body for supporting the back side of the electronic device and being fixedly connected with the bottom supporting board, position limiting portions provided on two sides of the screen of the electronic device for limiting position of the film, and connecting portions provided on two sides of the electronic device for fixedly connecting the base body with the position limiting portions.

Preferably, the connecting portion have an inner shape matching with the shape of the two sides of the electronic device.

In the present invention, the tail board, the bottom supporting board and the surface pressing board of the positioning device together forms a clamping structure with two folds. When in use, the positioning device can be engaged with the electronic device by inserting its pin into the functional port. The tail board can be used as a means to guide the positioning device during the insert procedure, so as to align the pin with the functional port and then insert into it, such that the positioning device itself can be located in a middle position. At the same time, the positioning element can be engaged with edge of the button, so as to locate it in a middle position of the button and so as the plan position. Before engaging the positioning device with the electronic device, the positioning element can be put inside the button hole of a film with its back layer tore away, such that the bottom portion of the film can be located in a middle position and the button location is precisely aligned. Then the top portion of the film can be limited on its two sides using fingers to locate the entire film in a middle position, after which the whole piece of film can be gradually pasted and then the positioning device can be removed. After eliminating bubbles and removing the front layer of the film, the film pasting for the electronic device can be done quickly and precisely.

### BRIEF DESCRIPTION OF THE DRAWINGS

FIG. 1 shows a schematic view of a first embodiment of the positioning device for pasting a film according to the present invention viewed in a first direction.

FIG. 2 shows a schematic view of the bottom supporting board and the pin of the positioning device in FIG. 1 viewed in a second direction.

FIG. 3 shows a schematic view of a second embodiment of the positioning device according to the present invention having a base body.

FIG. 4 shows a schematic view of the engagement of the second embodiment of the positioning device having a base body with an electronic device.

FIG. 5 shows a schematic view of the surface pressing board of the positioning device according to the present invention with another structure.

FIG. 6 shows a schematic view of a third embodiment of the positioning device according to the present invention.

FIG. 7 shows a lateral cross-section view of the positioning device in FIG. 6.

FIG. 8 shows a schematic view of a film according to the present invention.

FIG. 9 shows a schematic view of another film according to the present invention.

### DETAILED DESCRIPTION OF THE INVENTION

The spirit of the present invention will be apparent and elucidated from the following detailed description of specific examples, reference being made to the accompanying drawings.

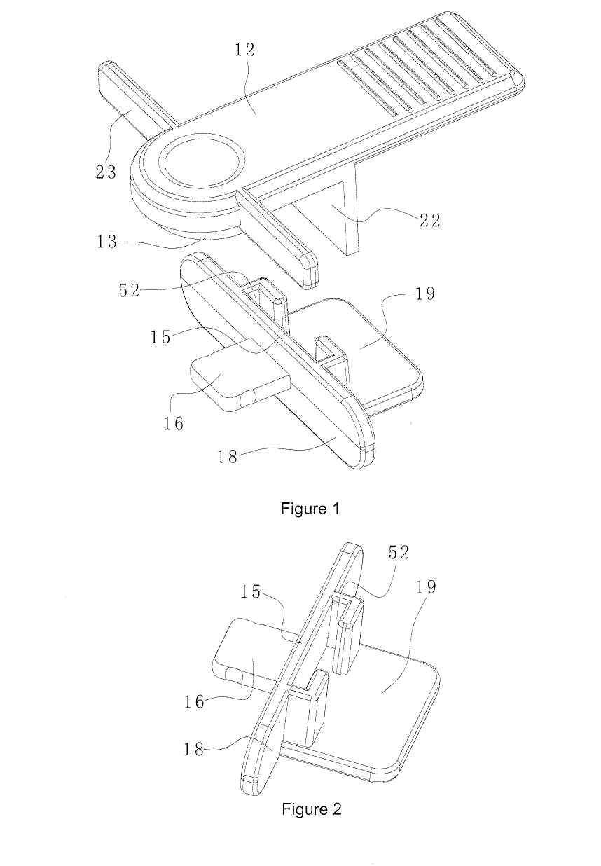

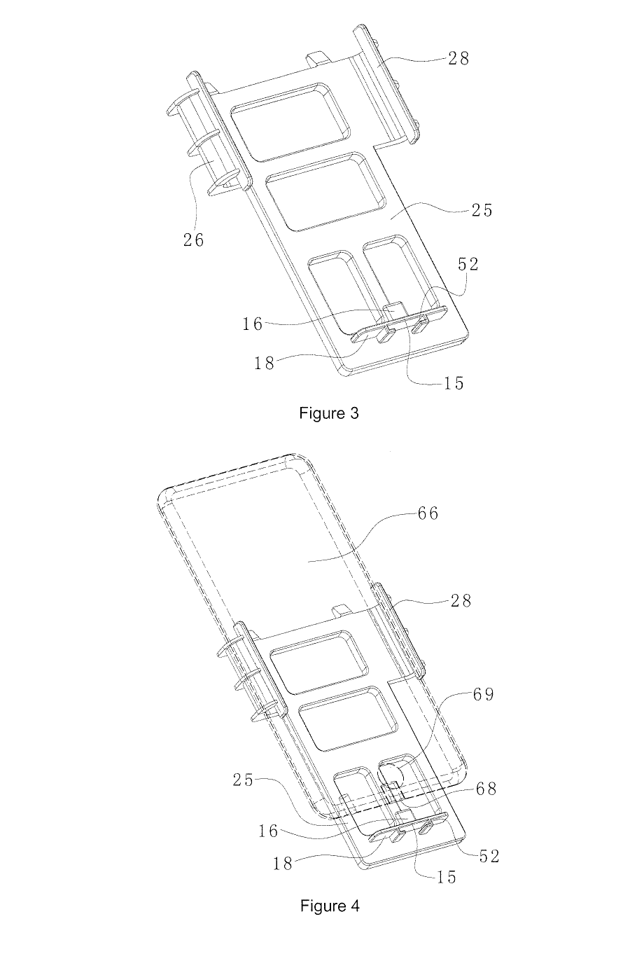

FIGS. 1 to 4 show a positioning device for pasting a film according to the present invention. The positioning device is suitable for auxiliary positioning when pasting a screen protecting film to an electronic device 66. The electronic device has a functional port 68 in its bottom end surface and a button 69 on its front surface adjacent to the functional port 68. The positioning device comprises: a tail board 19 parallel to the back side of the electronic device 66, a bottom supporting board 15 perpendicular to the tail board 19 and integrally formed with the tail board, a surface pressing board 12 parallel to the tail board 19 and connected with the bottom supporting board 15, a pin 16 provided on the inner side of the bottom supporting board 15 and extending inwards and having a shape and a size matching with that of the functional port 68, a positioning element 13 engagable with the button 69 which is provided on the inner side of the surface pressing board 12 and projects inwards and has a shape and a size matching with that of the button 69. In addition, the tail board 19 is provided on the outer side of the bottom supporting board 15.

The shape of the positioning element 13 can be a circle when the button 69 of the electronic device 66 has a circular shape, and the shape of the positioning element 13 can be a long circle when the button of the electronic device 66 has a long circular shape. The pin 16 has a shape matching with that of the functional port so as to be suitable to be inserted into the functional port 68 of the electronic device. Slots can be provided in the inner of the pin to avoid being in contact with any connector inside the port. The pin 16 can be a solid structure if there is no connector in the port. Usually the functional port 68 is a communication port or charge port, which is insertable with a communicating or charging connector.

The tail board 19, the bottom supporting board 15 and the surface pressing board 12 together forms a clamping structure with two folds. The surface pressing board 12 is integrally formed or engaged in the positioning device, and the distance from the bottom surface of the tail board 19 to the end surface of the positioning element 13 equals to the thickness of the electronic device. The positioning device can be engaged with the electronic device 66 by inserting its pin into the functional port 68. The tail board 19 can be used as a means to guide the positioning device and to support the bottom surface during the insert procedure, so as to align the pin 16 with the functional port 68 and then insert into it, such that the positioning device itself can be located in a middle position. At the same time, the positioning element 13 can be engaged with edge of the button 69, so as to put it in a middle position of the button and so as the plan position.

Then the surface pressing board 12 can be slightly lifted up to form a gap, such that a film with its back layer tore away can be inserted into the gap, and edge of the button hole in the film can be configured to surround the positioning element 13. Since the positioning element 13 has a cross-sectional shape consistent with the shape of the hole in the film, the bottom portion of the film can be located in a middle position and the button location is precisely aligned. Alternatively, the positioning element 13 can be located inside the button hole of the film before engaging the positioning device with the electronic device to achieve a precise positioning. Then the top portion of the film can be limited on its two sides using fingers to locate the entire film in a middle position, after which the whole piece of film can be gradually pasted and then the positioning device can be removed. After eliminating bubbles and removing the front layer of the film, the film pasting for the electronic device can be done quickly and precisely.

If the opening in the film is extended to the bottom edge of the film, the film can be inserted to the positioning element from its side. Of course, the opening should have a size larger than or equal to the diameter (if the positioning element is in a circular shape) or maximum width (if the positioning element is in a non-circular shape, e.g., a flat, oval or long circular shape) of the positioning element.

Preferably, the back side of the tail board 19 is in alignment with the back side of the electronic device 66. On a flat work surface, both the back side of the tail board 19 and the back side of the electronic device 66 are base surfaces for positioning. The tail board 19 can be pressed using fingers so as to push the positioning device to move forward, or the tail board 19 can be held up to allow the pin being smoothly inserted into the functional port.

Preferably, as shown in FIGS. 6 and 7, in another embodiment, the positioning device comprises a back board 11. The back board is provided on the back side of the electronic device and parallel to the surface pressing board 12, and the back board 11 is integrally formed with the bottom supporting board 15. The tail board 19 reverses to the opposite direction to form the back board 11 to clamp and support the back side of the electronic device, such that the back board 11 is resting on the back side of the electronic device, further improving clamping stability and positioning precision.

Preferably, positioning wings 18 are formed by the bottom supporting board 15 extending to its left and right sides. The positioning wing is in a board shape. When the pin 16 is inserted into the functional port 68, the inner side of the positioning wing 18 rests on the bottom end surface of the electronic device, assisting the positioning of the device itself and further improving positioning precision. Since the positioning wing 18 is such formed, it can have a thickness consistent with that of the bottom supporting board 15.

Preferably, the positioning element 13 is provided in its inner end surface with a rounded or chamfered edge, which will be engaged with the edge of the button that is generally lowered, allowing automatic positioning of the positioning element 13 and thus improving positioning precision.

Preferably, a guiding slope is provided in the front end of the back board 11 for guiding the positioning device to be inserted into the electronic device.

Preferably, the bottom supporting board 15 is provided with a slot 52, and the surface pressing board 12 is provided with a plug 22 for non-rotatable engaging with the slot 52, such that the surface pressing board 12 can be stably engaged with the bottom supporting board 15 to keep the position relationship between them.

Preferably, the plug is a flat positioning pin 22 perpendicularly provided on the inner side of the surface pressing board 12. It can not only tightly connect the surface pressing board 12 with the bottom supporting board 15, but also prevent rotation between them, keeping a precise position relationship between the positioning element 13 and the pin 16.

Preferably, as shown in FIGS. 6 and 7, the surface pressing board 12 is integrally formed with the bottom supporting board 15, so as to keep a precise position relationship between the positioning element 13 and the pin 16.

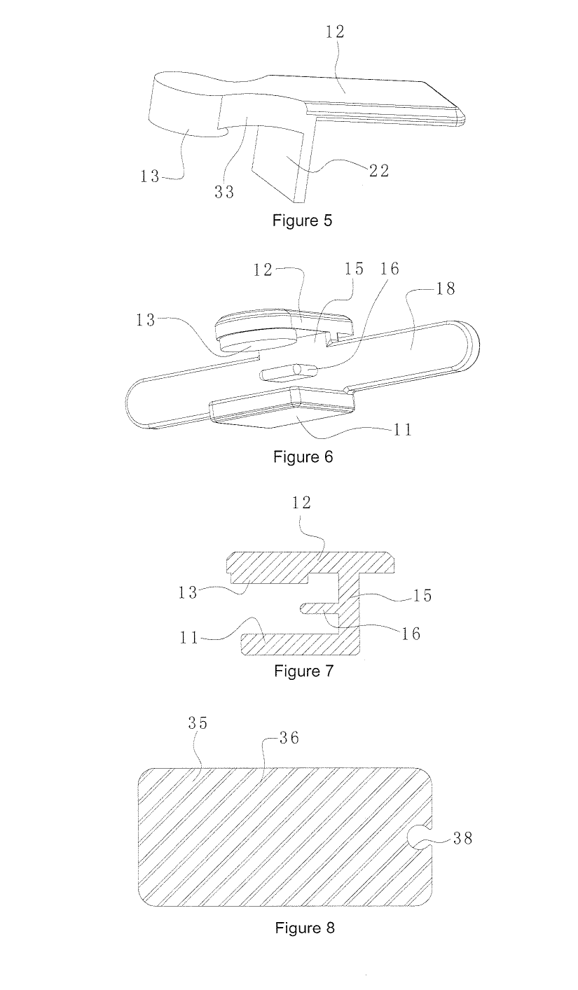

Preferably, as shown in FIGS. 5 and 8, a front end portion of the surface pressing board 12 is in a shape and a size consistent with that of the positioning element 13, and a connecting neck portion 33 of the surface pressing board 12 is smaller than the positioning element 13. In other words, the opening 38 in the film 35 has an edge width smaller than the diameter of the button, such that the opening 38 in the film 35 can be put around the positioning element 13 from top to bottom. In this way, the positioning device can be engaged with the electronic device first, and then the film can be introduced, facilitating the arrangement and position adjustment of the film.

Preferably, the positioning element 13 is in a circular shape, and the part of the front end portion of the surface pressing board 12 that is in a shape and a size consistent with that of the positioning element 13 is more than or equal to 240° of the circumference of the circular shape. The film can be rotated during the introducing of the film 35, allowing the boundary of the film 35 fall exactly on the boundary of the screen, but not inside the boundary of the screen which will affect display and view of the screen.

Preferably, the surface pressing board 12 is provided with laterally extending wings 23 on its two sides for preventing upwards extending of the lower edge of the film.

Preferably, the positioning device further comprises: a base body 25 for supporting the back side of the electronic device and being fixedly connected with the bottom supporting board, position limiting portions 28 provided on two sides of the screen of the electronic device for limiting position of the film, and connecting portions 26 provided on two sides of the electronic device for fixedly connecting the base body 25 and the position limiting portions 28. This arrangement can further limit the side position of the film from its two sides, facilitating alignment and precise pasting of the film.

Preferably, the connecting portions 26 have an inner shape matching with the shape of the two sides of the electronic device, which improves positioning precision of the positioning device itself and thus improving the positioning precision of the boundary of the film.

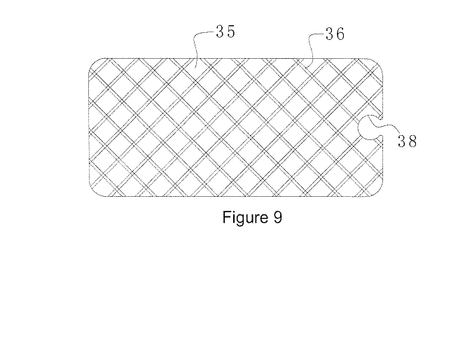

As shown in FIGS. 8 and 9, for fast and precise film pasting, a film is provided according to the present invention, which can be pasted utilizing the positioning device as mentioned above. A position of the film corresponding to the position of the button is provided with an opening insertable of the positioning element. The film comprises successively a back layer, a main layer and a front layer which are adhered together, and sloping strips 36 with chromatic aberration are printed on the surface of the front layer. The sloping strips 36 are strips of color having distinct difference with the color of the screen and periphery of the electronic device, and having angle with the edge of the film, which can be used as a comparative reference for positioning of the film using eyes, facilitating adjustment of the edge position of the film by eyes, so as to more precisely position the edge of the film and to improve the pasting precision of the film.

Preferably, the sloping strips 36 comprises two colors which are alternating with each other or intersecting to be a grid. The strips are formed by solid lines or close-packed character strings, such that at least one color can be used as a comparative reference for position adjustment for electronic devices of different colors, giving the film 35 a good universality.

Preferably, the two colors of the sloping strips are red and white, which can be used as a comparative reference for electronic devices of various colors and to complete film pasting. Strips of red color can be used as a comparative reference for electronic devices of colors that has distinct difference with red color, such as white, black, blue, or the like. Strips of white color can be used as a comparative reference for electronic devices of colors that has distinct difference with white color, such as red, orange, yellow, or the like.

As shown in FIGS. 8 and 9, for fast and precise film pasting, a method for pasting a screen protecting film is provided according to the present invention, which is suitable for pasting a film utilizing the positioning device as mentioned above. The film 35 comprises successively a back layer, a main layer and a front layer which are adhered together, and sloping strips 36 with chromatic aberration with the color of the screen are printed on the surface of the front layer. The method comprises: engaging the positioning device with the electronic device, with the back board resting on the back side of the electronic device, the bottom supporting board supporting the bottom of the electronic device, the pin inserted into the functional port, and the positioning element engaging with the periphery of the button; removing the back layer of the film; inserting the positioning element into the opening in the film; aligning the edge of the film with the edge of the screen basing on the sloping strips 36, gradually pasting the film on the screen, eliminating bubbles present between the film and the screen, and removing the front layer of the film to complete the film pasting. The sloping strips 36 are strips of color having distinct difference with the color of the screen and periphery of the electronic device, and having angle with the edge of the film, which can be used as a comparative reference for positioning of the film using eyes, facilitating adjustment of the edge position of the film by eyes, so as to more precisely position the edge of the film and to improve the pasting precision of the film.

It should be understood that various example embodiments have been described with reference to the accompanying drawings in which only some example embodiments are shown. The present invention, however, may be embodied in many alternate forms and should not be construed as limited to only the example embodiments set forth herein.

What is claimed is:

1. A positioning device for pasting a film, wherein the positioning device is suitable for auxiliary positioning when pasting a screen protecting film to an electronic device wherein the electronic device has a functional port in its bottom end surface and has a button on its front surface adjacent to the functional port, wherein the positioning device comprises:
a tail board parallel to a back side of the electronic device, a bottom supporting board perpendicular to the tail board and integrally formed with the tail board,
a surface pressing board parallel to the tail board and connected with the bottom supporting board,
a pin provided on an inner side of the bottom supporting board and extending inwards and having a shape and a size matching with that of the functional port, and
a positioning element engagable with the button which is provided on an inner side of the surface pressing board and projects inwards and has a shape and a size matching with that of the button; and wherein
the tail board is provided on an outer side of the bottom supporting board.

2. The positioning device of claim 1, wherein a back side of the tail board is in alignment with the back side of the electronic device.

3. The positioning device of claim 1, further comprising a back board, wherein the back board is provided on the back side of the electronic device and parallel to the surface pressing board, and the back board is integrally formed with the bottom supporting board.

4. The positioning device of claim 1, wherein board shaped positioning wings are formed by the bottom supporting board extending to its left and right sides, and a guiding slope is provided in a front end of the back board.

5. The positioning device of claim 1, wherein the bottom supporting board is provided with a slot, and the surface pressing board is provided with a plug for non-rotatable engaging with the slot.

6. The positioning device of claim 5, wherein the plug is a flat positioning pin perpendicularly provided on the inner side of the surface pressing board.

7. The positioning device of claim 1, wherein the surface pressing board is integrally formed with the bottom supporting board.

8. The positioning device of claim 1, wherein a front end portion of the surface pressing board is in a shape and a size consistent with that of the positioning element, and a connecting neck portion of the surface pressing board is smaller than the positioning element.

9. The positioning device of claim 8, wherein the positioning element is in a circular shape, and a part of the front end portion of the surface pressing board that is in a shape and a size consistent with that of the positioning element is more than or equal to 240° of a circumference of the circular shape.

10. The positioning device of claim 1, wherein the surface pressing board is provided with laterally extending wings on its two sides for preventing upwards extending of the film.

11. The positioning device of claim 1, further comprising:
a base body for supporting the back side of the electronic device and being fixedly connected with the bottom supporting board,
position limiting portions provided on two sides of the screen of the electronic device for limiting position of the film, and
connecting portions provided on two sides of the electronic device for fixedly connecting the base body with the position limiting portions.

12. The positioning device of claim 11, wherein the connecting portion have an inner shape matching with that of the two sides of the electronic device.
